(19) United States
(12) Patent Application Publication
(10) Pub. No.: US 2013/0110744 A1
(43) Pub. Date: May 2, 2013

(54) SYSTEM FOR CALCULATING COST FOR PRINTING

(71) Applicants: Odhran Hendley, Dublin (IE); Eduardo Macias, Colnee Meath (IE); William Jon Rittgers, Kildare (IE); Bryan Murphy, Dublin (IE); Michael Mulloy, Dublin (IE)

(72) Inventors: Odhran Hendley, Dublin (IE); Eduardo Macias, Colnee Meath (IE); William Jon Rittgers, Kildare (IE); Bryan Murphy, Dublin (IE); Michael Mulloy, Dublin (IE)

(21) Appl. No.: 13/282,253

(22) Filed: Oct. 26, 2011

(51) Int. Cl. G06F 17/00

(52) U.S. Cl. 705/413

(57) ABSTRACT

A system for calculating a cost for printing is disclosed herein. A method for calculating the cost includes receiving a print job including print job characteristics and determining a printer classification for a printer. A controlled representative volume of ink to print the print job is determined, responsive to the print job characteristics and the printer classification. The controlled representative volume of ink is independent of a variation within the printer classification.

### BACKGROUND

The present disclosure relates generally to systems and methods for calculating a cost for printing.

Systems for calculating print cost are commonly used to track and predict monetary charges for usage of printing systems. Previous systems exist for managing print costs based upon, e.g., the number of ink drops used for a specific print job at a specified cost per drop.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic illustration of an example of a system for calculating a cost for printing according to the present disclosure;

FIG. 2 is a schematic illustration of examples of sub-components of the example of the system of FIG. 1;

FIG. 3 is a semi-schematic illustration of an example of a print cost calculator according to the present disclosure;

FIG. 4 is a semi-schematic illustration depicting an example of a print cost calculator implemented in a cloud according to the present disclosure; and

FIG. 5 is a flow diagram depicting an example of a method according to the present disclosure.

### DETAILED DESCRIPTION

The present disclosure includes examples of a system and method that standardize costs for printing. In some cases, printer variation may cause printers of the same printer classification (e.g., printer model/model platform) to use different amounts of ink in performance of the same job, thereby resulting in print cost variation. Examples of the system and method as disclosed herein standardize costs for printing, and allow users to receive normalized, consistent cost estimates for printing charges.

Generally, the system determines a number of drops of ink to print a print job. In examples of the present disclosure, the determined number of drops may be independent of variation within a printer classification. The analysis of the ink volume to print a job may occur locally or at the cloud level. At the cloud level, a universal costing method for printing may be used, incorporating sender and receiver cost parameters to allow the job cost to be determined. Examples of the disclosed system and method are in sharp contrast to printing services that estimate the cost of a print job based on a predetermined cost per page (i.e., a flat cost per page regardless of the amount of ink per page). Further, examples of the present disclosure may allow appropriate adjustment of the point of purchase price and ink fill levels for use with pay-as-you-go type account management. Also, examples of the present system allow more appropriate alignment of the price of printing with the cost of printing.

The cost of ink may be a significant portion of the cost of printing a job. As such, the volume of the ink is an element in determining the cost of a print job. Various factors allow for estimation of print ink volumes in order to keep costs consistent. In examples of the present disclosure, cost may be standardized by replacing actual printing variables with fixed representative values for the purpose of calculating print job cost. For example, one printer may use 5,000 drops to complete a job; while another printer of the same classification may use 5,100 drops to complete the same print job. Examples as disclosed herein use a controlled representative value (such as, e.g., 5,050 drops) for both jobs, which may lead to a more satisfactory experience for the user. It is to be understood that the examples of numbers of drops for completing jobs referred to herein are illustrative in nature and are not intended to be indicative of actual volumes of ink used in print jobs.

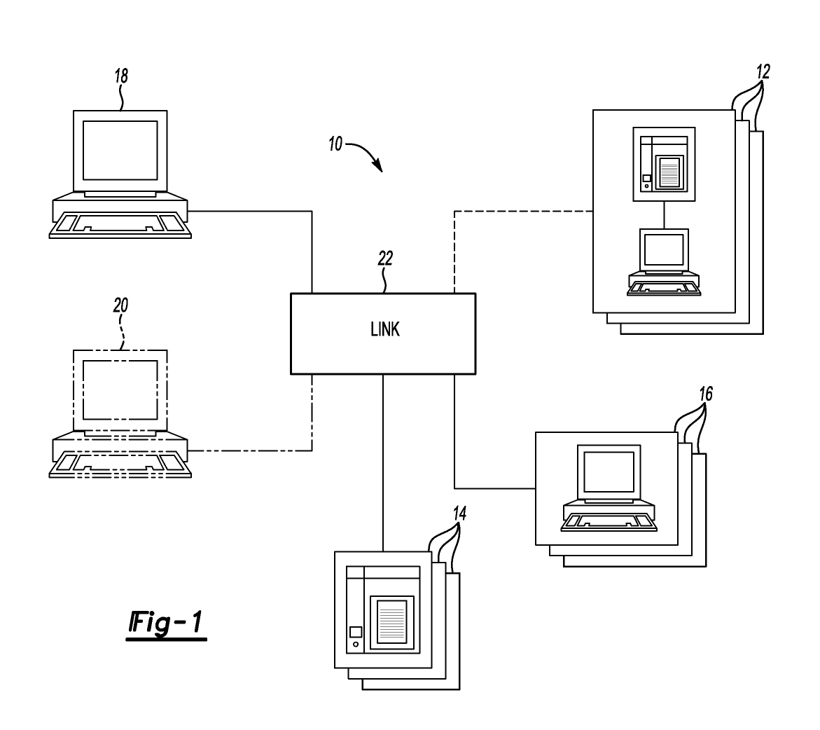

Referring now to FIG. 1, an example system for calculating a cost for printing is designated generally at 10. System 10 may include stand-alone print sites 12, network printers 14, network clients 16, and a print site 18. Further examples of system 10 may include a credit site 20 (as shown in phantom in the figure). Stand-alone print site 12 represents generally any device or combination of devices capable of printing without third party support. The path between link 22 and stand-alone print sites 12 is depicted by a dashed line to indicate the capability of printing without third party support. Examples of print site 12 may include printers with copy capabilities and printers operatively connected to computers. Stand-alone print sites 12 may, in some instances, use network resources to produce printed pages. Network printer 14 may be any device capable of producing printed pages from print jobs routed via a network. A network client 16 may be any device capable of electronic network communication. Examples of network clients 16 may include computers running programs for interacting with print site 18 (and credit site 20 if included in system 10). This interaction may include instructing print site 18 to deliver a print job to a selected network printer 14.

Print site 18 may be one or more computing devices capable of receiving and responding to network requests from a network client 16 for the purpose of directing print jobs to a network printer 14. Credit site 20 may be one or more computing devices capable of receiving and responding to requests from one or more of the network clients 16 for the purpose of acquiring credit to be added to a credit balance maintained by a stand-alone print site 12 and a network printer 14.

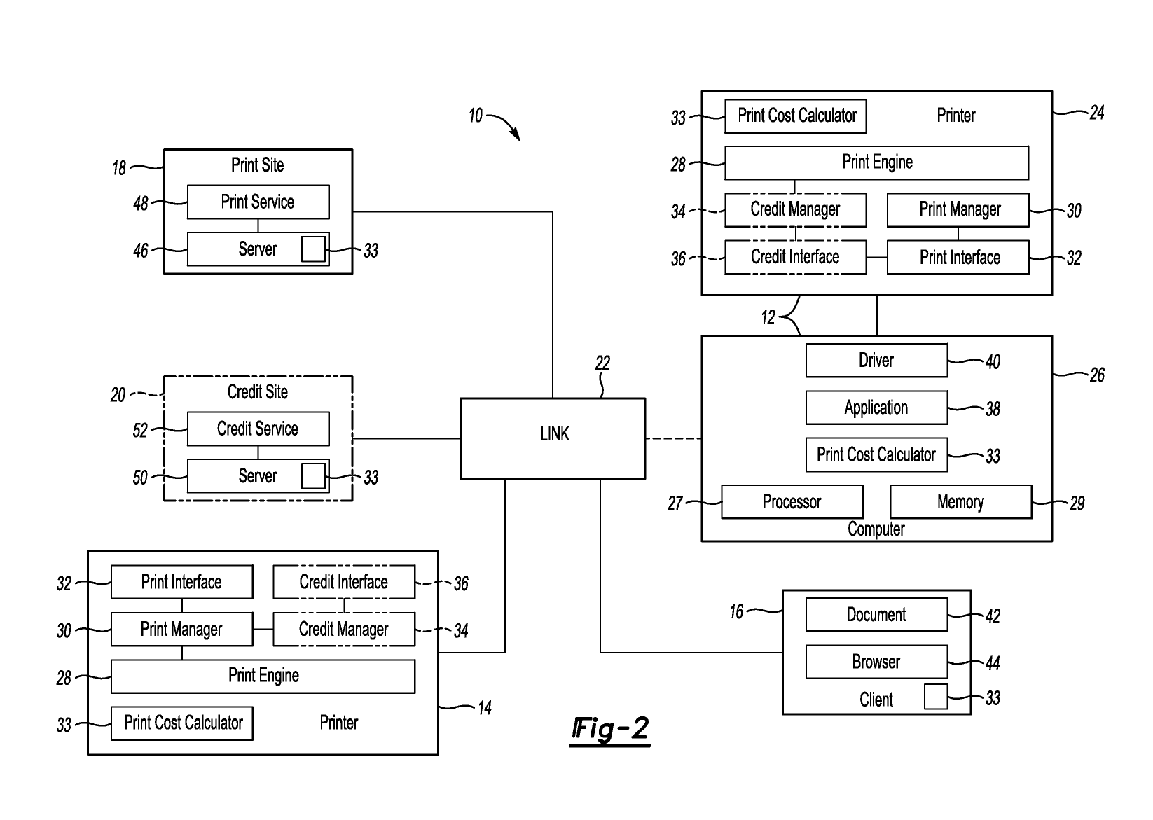

In an example, a network printer 14, a network client 16, a print site 18, and a credit site 20 are interconnected via a link 22. Link 22 may represent generally one or more of cable, wireless, fiber optic, or remote connections via telecommunication links, infrared links, radio frequency links, or any other connectors or systems that provide electronic communication. Link 22 may include, at least in part, an intranet, the Internet, or a combination of both. Link 22 may also include intermediate proxies, routers, switches, load balancers, and the like. It is to be understood that the paths followed by link 22 between components 14, 16, 18 and 20 as depicted in FIGS. 1 and 2 represent the logical communication paths between these devices, not necessarily the physical paths between the devices.

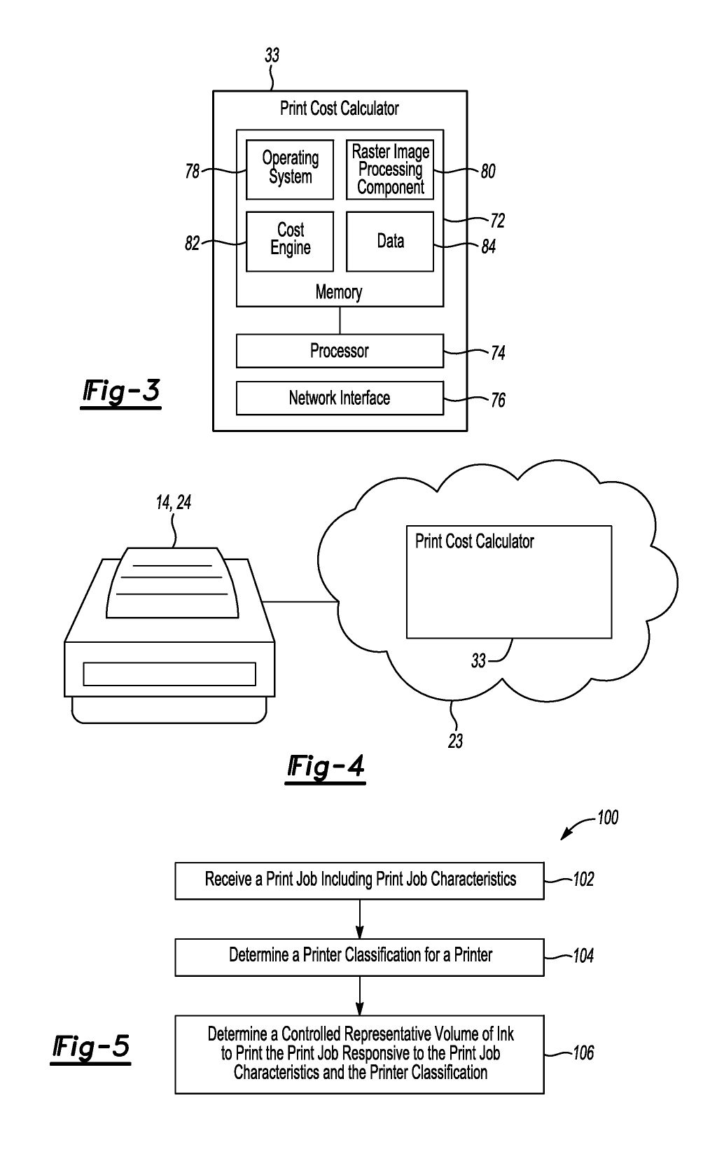

Referring further to FIG. 2, stand-alone print site 12 includes a printer 24 and a computer 26. Printer 24 may be a device capable of producing printed output on its own or at the direction of computer 26. Examples of printer 24 may include a print engine 28, a print manager 30, a print interface 32, and a print cost calculator 33 (shown in further detail in FIG. 3). Other examples of printer 24 may include a credit manager 34 and a credit interface 36, as shown in phantom in FIG. 2. Print engine 28 may include the physical components for forming printed images on a medium such as paper. These components may use consumable colorants such as ink or toner to produce the printed images.

It is to be understood that print cost calculator 33 may be implemented in any one of, or in any combination of printers 14, 24, sites 18, 20, clients 16, or computers (e.g., computer 26, though it is to be understood that computing devices may be associated with any or all of sites 18, 20, clients 16, and printers 14, 24) of system 10. However, it is to be further understood that print cost calculator 33 is not necessarily implemented in all of the above-listed components.

Print manager 30 may be any combination of hardware, software and firmware capable of directing print engine 28 to produce a desired image from a print job. Print interface 32 may be any combination of hardware, software and firmware capable of receiving print jobs and forwarding those print jobs to print manager 30. Print interface 32 may be capable of wired or wireless communication with, for example, computer 26. In an example, if printer 24 includes a copy function, print interface 32 may receive print jobs from a scanner (not shown).

In examples of printer 24 including credit manager 34/credit interface 36, the credit manager 34 may be a combination of hardware, software and firmware capable of maintaining a credit balance, allowing print engine 28 to produce jobs when the balance is sufficient to cover the cost of producing those jobs. In an example, credit manager 34 deducts from that balance as pages are printed, and increases the credit balance when it receives a code that uniquely identifies printer 24 and specifies the amount of credit to be added. The added credit may be purchased or transferred from another printer. Credit interface 36 may be any combination of hardware, software and firmware capable of receiving the codes for credit manager 34. Credit interface 36 may, for example, be capable of receiving the codes electronically via a wired or wireless connection. In such a case, credit interface 36 and print interface 32 may share common components so that a code may be supplied along with, or as part of a print job. In another example, credit interface 36 may allow for manual entry of codes through a user interface, such as, e.g., a touch screen or keypad associated with printer 24. Credit interface 36 may include a scanner, and as such, may read codes such as barcodes.

Computer 26 may be any computing device capable of communicating print jobs to printer 24. In an example, computer 26 may include application 38, driver 40, and print cost calculator 33. Application 38 is responsible for generating a document to be printed. Driver 40 translates the document into a print job formatted for printer 24, and communicates the print job to printer 24. The system 10 may include a computer 26 remote from, and in selective network communication with printers 14, 24. The computer 26 includes a processor 27 and memory 29 operatively disposed therein, and may also include the print cost calculator 33 operatively disposed therein.

Printers 14 and 24 are similar in many respects. However, where printer 24 is designed to receive print jobs directly from computer 26, printer 14 may receive print jobs from print site 18 via link 22. Network client 16 may include document 42, browser 44, and print cost calculator 33. Document 42 represents generally any electronic content that may be printed. Various examples of document 42 include word processing documents, spreadsheets, web pages, images, and/or the like. Browser 44 is responsible for communicating the document 42 to print site 18 for processing so that it may be printed using, e.g., printer 14.

Print site 18 may include a server 46 and a print service 48. Server 46 may be any combination of hardware, software, and firmware capable of receiving and responding to requests originating from client 16. These communications include receiving and forwarding documents to print service 48. Print site server 46 may include print cost calculator 33. Print service 48 may be any combination of hardware, software, and firmware capable of formatting documents received from client 16 to generate print jobs to be produced by printer 14. In some examples, print service 48 may also be responsible for interacting with credit site 20 to provide printer 14 with compensation for producing a print job. The compensation may take the form of a code used by printer 14, 24 to add to its credit balance.

Credit site 20 includes a server 50 and a credit service 52. Server 50 may be any combination of hardware, software, and firmware capable of receiving and responding to requests originating from client 16, computer 26 and print site 18. Credit site server 50 may include print cost calculator 33. Credit service 52 may be any combination of hardware, software, and firmware capable of generating codes for use by printers 14 and 24 for adding to their respective credit balances. In an example, printer 14 may have codes delivered electronically, needing no user intervention. In an example of printer 24, codes may be delivered via e-mail to computer 26. A user may then manually enter the code via credit interface 36, or communicate the code to printer 24 using driver 40.

A more detailed description of examples of credit site 20 may be found in U.S. patent application Ser. No. 12/721,434, filed Mar. 10, 2010 and entitled “PRINTER CREDIT MANAGEMENT”, which application is incorporated herein by reference in its entirety.

Printer 14 receives print jobs from client 16 via print site 18. Printer 24 receives print jobs from computer 26. Each print job has an associated cost. System 10 for calculating the cost for printing further includes print cost calculator 33, discussed briefly above, implemented at the local/network printer level (as shown in FIG. 2) or at the cloud level (e.g., cloud printing, as shown in FIG. 4).

Referring now to FIG. 3, a schematic illustration of an example of print cost calculator 33 is shown. Print cost calculator 33 is operatively associated with a non-transitory tangible computer-readable medium/memory 72 having embedded therein instructions executable by a processor 74 of the print cost calculator 33. The print cost calculator 33 may include a network interface 76.

In a given implementation, processor 27, 74 may represent multiple processors, and the memory 29, 72 may represent multiple memories. In an example, the print cost calculator 33 may include a number of software components that are stored in a computer-readable medium (e.g., memory 72) and are executable by processor 74. In this respect, the term “executable” includes a program file that is in a form that can be directly (e.g., machine code) or indirectly (e.g., source code that is to be compiled) performed by the processor 74. An executable program may be stored in any portion or component of the memory 72.

Memory 72 may include an operating system 78, a raster image processing (RIP) component 80, a cost engine 82, and data 84. It is to be noted that memory 29 may also include similar components (though not shown). The operating system 78 represents generally any software platform on top of which other programs or applications such as the RIP component 80 and the cost engine 82 run. Examples include Linux® and Microsoft Windows®. RIP component 80 represents generally any combination of hardware and software capable of converting digital information about fonts and graphics that describes the intended appearance of the content, and translating that information into an image composed of individual dots that a printer can output. In examples, RIP component 80 may be additionally configured to compose page layouts and scaling operations.

It is to be understood that the computer-readable storage medium/memory 72 may include various types of memory modules, including volatile and nonvolatile memory. As an example, the computer-readable storage medium 72 may include Random Access Memory (RAM), Read Only Memory (ROM), and Hard Disk Drive (HDD) memory. It is believed that other types of memory may also be used. In some instances, different types of memory in the computer-readable storage medium 72 may be used for different data storage needs. For example, the processor 74 may boot from ROM, maintain nonvolatile storage in the HDD memory, and execute program code stored in RAM.

It is to be understood that the computer-readable storage medium 72 may be an electronic, magnetic, optical, electromagnetic, infrared, or semiconductor system, apparatus, or device, or any suitable combination thereof. More specific examples of the computer-readable storage medium 72 may include, for example, the following: a portable computer diskette, a hard disk, a RAM, a ROM, an erasable programmable read-only memory (EPROM or Flash memory), a portable compact disc read-only memory (CD-ROM), an optical storage device, a magnetic storage device, or any suitable combination thereof.

The computer-readable medium/memory 72 and/or memory 29 may have instructions embedded therein to receive a print job including print job characteristics. Instructions to determine a controlled representative volume of ink to print the print job responsive to the print job characteristics, and to the printer classification may further be embedded in the computer-readable medium 72, 29. The controlled representative volume of ink is independent of a variation within the printer classification. Instructions may also be included to classify a printer 14, 24 in response to a printer identifier of the printer 14, 24.

As used herein, print job characteristics include factors such as print content, print mode, and number of copies. “Print content”, as used herein, refers to information that may be received and/or stored by a computer system to be printed. The print content may include on-screen content, font types, colors or anything to be depicted on a printed medium. Print content further may include media type. “Media type” as used herein may include paper type and size, for example, legal size plain paper, letter size plain paper, letter size photobase paper, etc. Further, media may be chosen from a cellulose paper base, coated papers, papers including: polyethylene; polypropylene; polyethylene terephthalate; polylactic acid; or combinations thereof, metal sheets, metal foils, and combinations thereof. In some examples disclosed herein, a printer may include a sensor to determine the type of media and allow the media type to be included automatically in the print content. In other examples, a user may be informed that the type of media loaded in the printer does not agree with the type of media included in the cost. As such, appropriate remedial action may be taken to revise the cost, or install different media.

“Print mode”, as used herein, refers to information that may be determined from user input for selecting quality and format of printing. The print mode may include quality settings such as fast-draft, normal, best, custom, desired dry time and customized drop size; color settings such as black-and-white vs. color or sepia; and material conservation settings such as single-sided or double-sided output. In other examples, print mode may include enlarging/scaling operations.

A printer identifier of the printer may include an identifying code that is translatable to a printer classification. For example, printers having certain model numbers may belong to the same printer classification where the only difference may be a color of a housing. Further, a printer identifier may include a serial number, firmware version, internet protocol (IP) address, e-mail address, or other data that distinguishes the printer from other printers.

“Color map”, as used herein, translates image color space into printer color space. Image color space may be translated into printer color space by using a color look up table. The printer color space may be in, for example, a three- or four-dimensional space, with each dimension corresponding to a color of ink. As such, any image color may be translated by the color map to a set of color coordinates representing individual color contributions to create intended color output on the print media. The color map may be represented within the printer classification. In an example in which a printer has cyan, yellow, magenta and black inks, an image color “green” may map to a precise mixture of cyan and yellow inks. Any color in the gamut of the printer may be obtained by dispensing ink in a ratio of colors indicated by the color map.

FIG. 4 is a semi-schematic illustration depicting an example of a print cost calculator 33 implemented in a cloud 23 according to the present disclosure. In the example depicted in FIG. 4, the print cost calculator 33 is physically external to the printer 14, 24. It is to be understood that the “cloud” 23 is a computer network accessible over the Internet and/or web that is dynamically scalable with virtualized resources, such as printing resources. In an example, the cloud may or may not be physically distributed. A user interoperating with the cloud is not required to have knowledge or expertise in the infrastructure of the cloud that relies on the Internet to satisfy his/her computing needs. The cloud may provide the services of the print cost calculator that are accessible from a web browser, while software and data are stored on servers in the cloud.

It is to be understood that a system for managing print jobs or print costs may be referred to as a “pipeline”. Generally a cost may be generated in a cost pipeline by using some information from a local printer and some information that may be predetermined and standardized for a particular printer classification. In an example, for individual print jobs, a print pipeline (parallel to the cost pipeline) facilitates print job delivery. The print pipeline uses information including the print job characteristics and the printer classification. This information may be manipulated to produce a final number of drops to print a page. In parallel, a cost pipeline generates a job cost by using the information from the print job characteristics and the printer classification, except a controlled representative drop weight (normalized by printer classification) is used. Each of the print pipeline and the cost pipeline calculations may be run on a single processor, though not necessarily running at the same time. Using these pipelines, standardized costs may be determined for printers in various printer classifications.

In an example, a print job may link to a subscription account with a cost pipeline/calculation at the cloud level. The cost pipeline/calculation may be calculated at a service provider to maintain cost consistency when printing identical print jobs on printers within a particular printer classification. For example, if printing on a remote printing account, communication may be sent from a receiving printer to the cloud. A sender could send media type and screen content information through the network interface. In an example, print job characteristics may be automatically adjusted based on predetermined parameters corresponding to the subscription account. The quality settings in the print mode may be adjusted to ensure the output remains within a cost previously established in a subscription agreement. In an example, the cost calculator receives sufficient information in order to calculate a cost for printing and, in some cases, adjust some of the print job characteristics to fit a new printer that is enabled.

The variation within the printer classification may be a hardware or firmware variation among a plurality of members of the printer classification. Hardware and firmware sources of variation may include a color map, installed ink type, wear, and manufacturing variation.

Firmware may be updated from time to time. In an example, a printer may include firmware as of initial purchase, and no firmware update may be needed throughout the life of the printer. Firmware may be provided as a service for post-purchase updating or customizing. The change in firmware may enable a pay-as-you-go type of account management. As such, firmware changes may enable a user to opt-in or opt-out of pay-as-you-go account management. It is to be understood that any source of variation in a printer classification that may be identifiable and quantifiable may be accounted for by the print cost calculator 33.

Examples of the system and method disclosed herein may yield different cost calculations for printing identical print jobs on printers of different printer classifications. This cost calculation information may inform a decision to select a printer classification for a print job based on the projected cost. For example, it may cost more to print a photograph on a general purpose color printer than on a specialized photo printer (e.g., OfficeJet® versus PhotoSmart®).

In examples of the disclosed system and method, instructions embedded in the computer-readable medium may determine another controlled representative volume of ink to print another print job responsive to the print job characteristics and the other printer classification. In other words, the print jobs are identical, but the printers are from a different printer classification. The controlled representative volume of ink from various printer classifications may be the same as or different from another controlled representative volume of ink for a particular print job.

Referring now to FIG. 5, an example of a method according to the present disclosure is designated generally at 100. Examples of method 100 may be carried out by instructions executable by one or more processors as discussed above. The instructions are embedded within the non-transitory, tangible computer-readable medium as also discussed above. Method 100 includes instructions to: receive a print job including print job characteristics 102; determine a printer classification for a printer 104; and determine a controlled representative volume of ink to print the print job responsive to the print job characteristics and the printer classification 106. In the method 100, the controlled representative volume of ink is independent of a variation within the printer classification. The instructions to determine the printer classification may further include instructions to classify the printer in response to a printer identifier of the printer.

It is to be understood that the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

It is to be understood use of the words “a” and “an” and other singular referents include plural as well, both in the specification and claims.

While several examples have been described in detail, it will be apparent to those skilled in the art that the disclosed examples may be modified. Therefore, the foregoing description is to be considered non-limiting.

What is claimed is:

1. A system for calculating a cost for printing, comprising:
a print cost calculator having operatively associated therewith a non-transitory, tangible computer-readable medium having embedded therein instructions executable by a processor associated with the print cost calculator, the instructions to:
receive a print job including print job characteristics;
determine a printer classification for a printer; and
determine a controlled representative volume of ink to print the print job responsive to the print job characteristics and the printer classification;
wherein the controlled representative volume of ink is independent of a variation within the printer classification.

2. The system as defined in claim 1 wherein the print job characteristics include a number of copies and one or more of print content and print mode.

3. The system as defined in claim 2 wherein the print content is chosen from on-screen content, font types, colors, media type, and combinations thereof; and print mode is chosen from a quality setting, a color setting, a material conservation setting, and combinations thereof.

4. The system as defined in claim 1 wherein the instructions to determine the printer classification include instructions to classify the printer in response to a printer identifier of the printer.

5. The system as defined in claim 1 wherein the variation within the printer classification is any of a hardware variation or a firmware variation among a plurality of members of the printer classification.

6. The system as defined in claim 1, further comprising an other printer having an other printer classification, wherein the system further includes instructions to determine an other controlled representative volume of ink to print an other print job responsive to the print job characteristics and the other printer classification.

7. The system as defined in claim 6 wherein the controlled representative volume of ink is the same as, or different from the other controlled representative volume of ink.

8. The system as defined in claim 1 wherein the print cost calculator is operatively disposed within the printer.

9. The system as defined in claim 1, further comprising a computer remote from, and in network communication with the printer, the computer having the print cost calculator and the processor operatively disposed therein.

10. A non-transitory, tangible computer-readable medium having embedded therein instructions executable by a processor for calculating a cost for printing, the instructions to:
receive a print job including print job characteristics;
determine a printer classification for a printer; and
determine a controlled representative volume of ink to print the print job responsive to the print job characteristics and the printer classification;
wherein the controlled representative volume of ink is independent of a variation within the printer classification.

11. The computer-readable medium as defined in claim 10 wherein the print job characteristics include a number of copies and one or more of print content and print mode.

12. The computer-readable medium as defined in claim 11 wherein the print content is chosen from on-screen content, font types, colors, media type, and combinations thereof; and print mode is chosen from a quality setting, a color setting, a material conservation setting, and combinations thereof.

13. The computer-readable medium as defined in claim 10 wherein the instructions to determine the printer classification include instructions to classify the printer in response to a printer identifier of the printer.
